(19) United States
(12) Patent Application Publication
(10) Pub. No.: US 2013/0038756 A1
(43) Pub. Date: Feb. 14, 2013

(54) LIFE-LOGGING AND MEMORY SHARING

(71) Applicant: Doreen CHENG, San Jose, CA (US)

(72) Inventor: Doreen CHENG, San Jose, CA (US)

(73) Assignee: Samsung Electronics Co., Ltd., Suwon City (KR)

(21) Appl. No.: 13/205,236

(22) Filed: Aug. 8, 2011

(51) Int. Cl. H04N 5/76

(52) U.S. Cl. 348/231.99; 348/E05.031

(57) ABSTRACT

In a first embodiment of the present invention, a method for creating a memory object on an electronic device is provided, comprising: capturing a facet using the electronic device; recording sensor information relating to an emotional state of a user of the electronic device at the time the facet was captured; determining an emotional state of the user based on the recorded sensor information; and storing the facet along with the determined emotional state as a memory object.

### BACKGROUND OF THE INVENTION

1. Field of the Invention

The present invention relates generally to consumer electronic devices. More specifically, the present invention relates to logging content and sharing memories.

2. Description of the Related Art

Capturing life memories (e.g., weddings, graduations, vacations, etc.) using a recording device has been a popular pastimes since at least the invention of the camera. In the mid-20^{th} century it became popular to utilize home movie cameras to capture such memories, later progressing to analog video cameras and then to digital video cameras. More recently, the number of devices available to a user to capture such life memories has exploded. Mobile devices, most particularly in the form of cellular phones, have become the prevalent mode of communication for many people. As these devices have become more powerful, the processing power and memory capabilities of these devices have allowed them to become closer to computers than phones. The addition of cameras (both video and still) into these mobile devices has allowed them to supplant many standalone video or still cameras in users' lives, although many other users still utilize such older devices in lieu of or in addition to smartphones. Tablet devices have also gained in popularity in recent years, and have the same potential to be used to capture life memories as smartphones (if not more so). It is therefore not uncommon for a single user to have a range of different devices available at his or her easy disposal to capture a life memory as it occurs.

Each of these devices initially stores the captured information in a memory on the device itself (e.g., flash memory in a smartphone). The user is then able to synchronize these devices with a more centralized device, such as a home computer, where the captured content can be joined with captured content from other devices. However, a user may have several such computers, and tracking what captured content goes where can be troublesome.

Even more recently, cloud based solutions have been proposed, where a user can upload captured content to a web site or other storage mechanism via the Internet. However, even these locations can be scattered, as one user can be a member of several different cloud services simultaneously. For example, the user may be able to upload pictures to a Facebook™ page, a Flickr™ account, or a MobileMe™ service. Thus the content is still scattered in various locations.

Additionally, it can be difficult for user to organize vast groups of captured content. Typically, for example, photos are stored chronologically. While this may make things easier when a user's memory is linked to a specific event, it can be troublesome when a user thinks in a non-chronological way. If a user wants to reminisce, for example, about a trip they took last summer, chronological ordering may be helpful, but a user may wish to reminisce less rigidly, perhaps wanting to remember all the times they visited Italy in their lives. Pictures of France and England taken last year on the summer trip that also involved a visit to Italy would not pertain to a grouping that is only supposed to include pictures of the 10 different times they visited Italy in their lives. The scattered nature of how these pictures could be stored makes such “story-based” groupings difficult.

Furthermore, thus far only the example of a single user has been discussed. But many different people capture such life events, and these life events can overlap in either direct (e.g., two different people who went on a trip together) or indirect ways (e.g., two different people who happened to visit Italy at some point). There may be circumstances where it would be beneficial to be able to link such life memory content, despite being scattered across multiple storage locations and across multiple users. This would foster “group reminiscing” that can aid in improving social relationships.

What is needed is a solution that addresses all of these concerns.

### SUMMARY OF THE INVENTION

In a first embodiment of the present invention, a method for creating a memory object on an electronic device is provided, comprising: capturing a facet using the electronic device; recording sensor information relating to an emotional state of a user of the electronic device at the time the facet was captured; determining an emotional state of the user based on the recorded sensor information; and storing the facet along with the determined emotional state as a memory object.

In a second embodiment of the present invention, a device is provided comprising: a processor; a memory; one or more sensors designed to record sensor information relating to an emotional state of a user; a facet capture device, wherein the facet capture device is designed to capture a facet; wherein the processor is configured to determine an emotional state of the user based on the recorded sensor information, and store the facet along with the determined emotional state as a memory object in the memory.

In a third embodiment of the present invention, an electronic device is provided comprising: means for capturing a facet using the electronic device; means for recording sensor information relating to an emotional state of a user of the electronic device at the time the facet was captured; means for determining an emotional state of the user based on the recorded sensor information; means for storing the facet along with the determined emotional state as a memory object; and means for obtaining a unique identifier for a physical object that is the subject of the facet; means for attaching the unique identifier to the memory object; and means for linking the memory object to other memory objects having similar attached unique identifiers.

In a fourth embodiment of the present invention, a non-transitory program storage device readable by a machine tangibly embodying a program of instructions executable by the machine to perform a method for creating a memory object on an electronic device, comprising: capturing a facet using the electronic device; recording sensor information relating to an emotional state of a user of the electronic device at the time the facet was captured; determining an emotional state of the user based on the recorded sensor information; storing the facet along with the determined emotional state as a memory object; and linking the memory object to other memory objects having similar stored emotional states.

### BRIEF DESCRIPTION OF THE DRAWINGS

FIG. 1 is a flow diagram illustrating easy composition of a shared memory among multiple users in accordance with an embodiment of the present invention.

FIG. 2 is a block diagram illustrating a system in accordance with an embodiment of the present invention.

FIG. 3 is a flow diagram illustrating a method for creating a memory object on an electronic device in accordance with an embodiment of the present invention.

FIG. 4 is a flow diagram illustrating a method for associating a memory object with a physical object in accordance with one embodiment of the present invention.

FIG. 5 is a flow diagram illustrating a method for using a memory object associated with a physical object in accordance with an embodiment of the present invention.

FIG. 6 is a flow diagram illustrating a method for facilitating group togetherness in accordance with an embodiment of the present invention.

FIG. 7 is a flow diagram illustrating a method for linking a memory object to a physical object and the other memory objects of the physical object in accordance with an embodiment of the present invention.

FIG. 8 is a flow diagram illustrating a method for recommending memory objects in accordance with an embodiment of the present invention.

FIG. 9 is a flow diagram illustrating a method for creating a memory object on an electronic device in accordance with another embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

For purposes of this document, content captured by a device may be termed a “facet”. Example facets include still pictures, videos, voice recordings, text messages, etc.

In the present document, various embodiments are presented relating to different ways facets can be augmented and easily shared between devices and users.

In an embodiment of the present invention, emotions and sentiments are captured in addition to facets. In that manner, the emotion of a life memory is captured along with the facets involving the life memory itself. For example, if the picture is taken at a birthday, one type of emotion may be tracked, while on a honeymoon trip another type of emotion may be tracked. This emotion/sentiment tracking may be performed automatically or semi-automatically while capturing the facets.

Furthermore, a “story” (a grouping of facets with an organized structure) may be automatically or semiautomatically composed using the information about the emotions/sentiments. This may be as simple as grouping facets having similar emotions/sentiments together, or may involve more complex organizational techniques such as narratives. The memory/story can then be easily edited, shared, and re-experienced because the emotion/sentiment is attached to the facet itself.

In another embodiment of the present invention, a facet (and ultimately the story in which it is organized) may be attached to a physical object. This may be accomplished by obtaining a unique identification for the object (such as by bar code or RFID scanning, or via image or text recognition software). The unique ID can then be attached to the facet and stored with it, so it can be easily searched for and retrieved based on the unique ID.

In another embodiment of the present invention, a shared memory can be easily created with other people by using collaborative story composition tools.

Referring to the embodiments where emotions and/or sentiments are captured in addition to facets, user sentiments/emotions can be derived from sensor data. The sensor data can be gathered from one or more hardware or software sensors, either located on the device which is capturing the facet (e.g., a mobile phone if the mobile phone's camera is capturing the facet), or outside of the device which is capturing the facet (e.g., a networked facial recognition camera and software). Examples of sensors include physiological sensors such as heart rate monitors, blood pressure monitors, facial expression monitors (e.g., using a camera along with facial expression recognition software), voice sensors (e.g., microphones coupled with voice pattern recognition software to detect emotional patterns in users' voices), as well as data-related sensors, such as tracking what applications are being used or actions taken using the applications (e.g., buying, rating, or voting, or merely text entered) from which user likes/dislikes can be determined. Much research has shown the association between emotional states and physiological signals. With cloud computing and more powerful client devices, automatically estimating user emotional states becomes practical. Indeed, it is not even necessary for specialized sensor hardware to be used—much of the hardware on existing mobile devices (cameras, microphones, touch sensitive screens) can be used to measure physiological responses and determine emotional states.

Indeed, this embodiment of the present invention can be used with any sensor that can measure data that can be used, either explicitly or implicitly, to determine user emotion and/or sentiment.

Sensor data can also be used to infer a user's situation/context, which can be used to make a memory/store richer and more vivid. Data for this purpose may include, for example, time/date, location, weather, user movement, background sound or smells, etc. This data can be used along with other sensor data to make emotion/sentiment determinations more accurate. For example, a faster heart rate may be more likely to indicate a change in emotion if other sensors, such as accelerometers, indicate that the user is running (e.g., on a hiking trail). As such, the situation or context of the user can be used to make the emotion/sentiment data more accurate.

Based on the application needs, developers can choose the types of data to be recorded, when to record, and how frequently to record the data. A simple way of triggering the start and stop of the recording is to allow the user to have control. For example, an application can be provided for the user to choose among (1) automatically periodically recording (2) recording only when a start command is issued and stopping when a stop command is issued; or (3) when an activity in the facet-capturing activity set is started (e.g., when a picture is taken, or video recording started). The starting or ending of such activities can be detected, for example, when a corresponding application is opened or closed or when input is received in one of the applications from a user. The user could also set the amount of time to capture sensor data (e.g., 5 seconds before the facet is recorded and 5 seconds after).

The information from the various sensors can be weighted. In other words, data from some sensors, such as those that are more reliable or influential, can be valued more highly than data from other sensors, so as to increase the accuracy of the assessment. This weighting can be based not only on the inherent reliability of the sensor data (e.g., heart rate monitoring may be more reliable than voice tracking) but also based on the context in which the sensor data is gathered (e.g., voice recording is less reliable in a noisy environment than in a quiet one).

In one embodiment of the present invention, the system may, after a user has completed recording the facet, perform the emotion/sentiment analysis and present the results for the user for editing. In this manner, the user can modify the emotion/sentiment if he or she feels it is incorrect. For example, the sensor data may imply that the user was sad because crying and sobbing was detected, but the user may know that it was really “tears of joy” from watching her daughter get married, and thus may edit the “sad” emotion tagged to the photo to be a “joyful” emotion.

Furthermore, an editing application can offer a variety of tools. This may include, for example, tools for processing the sensor data to infer user sentiments/emotions, tools for automatic or semi-automatic vide/voice/photo editing and sound effect editing, tools for music selection, composition, tools for narrative composition, and tools for movie composition.

Once the user sentiments/emotions are identified, the system is capable of automatically infusing the story with the sentiment/emotion. In this way, the sentiment/emotions of various facets can not only be used to identify similar facets with which to be grouped, but also can be used to alter the presentation of the facets in the ultimate story. For example, if the facet emotions are all “sad”, then a ‘sad” musical composition can be automatically infused into the point in the story in which the facets are depicted. Alternatively, a list of likely appropriate musical selections can be presented to the user to choose.

Once the user has finished editing the story, the system can package the resulting story and upload it to a server or cloud. The designer of the system can decide whether to discard the original facets and sensor data or let the user make such a decision. The advantage of keeping them is that the facets may be used for other purposes in the future, and the sensor data can be accumulated for mining longer-term patterns. The disadvantage is that more bandwidth/time is required for uploading, more storage is required to keep them, and for most people a large percentage of the facets may not be reused.

For purposes of this document, the stories composed can be organized into various hierarchies. For example, a story may first be organized into a memory episode (e.g. daughter's wedding), and then multiple memory episodes may be organized into a movie (e.g., compilation of daughter's significant life events). The composition of the larger movie may also include utilizing previously unassigned facets in addition to the facets that had been previously organized into an episode. The storage of the sentiments/emotions along with the facets allows for much flexibility in how movies are compiled.

For both episode and movie composition, the system also can give the option of doing so automatically in a cloud or server without user intervention, or by involving the user in the process using a client device. Alternatively, the entire composition can be created on the client device.

The facets themselves can be stored in such a way as to accelerate and improve the accuracy of searches that attempt to locate them. For example, tags (as metadata) may be used to store the emotion/sentiment, comments from friends, and data indicating the context/situation can be stored along with the facets. In addition, speech recognition can be used to extract topical keywords from an audio stream of the facet (e.g., the audio portion of a video, or the entire audio of a phone call conversation). The keywords can then be used to index the facet, much in the same way that keywords from a web page are used to index a search engine.

The stored facets can also be organized to capture the relationships between facets. In a simple case, a memory movie comprises one or more memory episodes. An episode can be used in one or more movies. An episode can contain one or more different types of facets, such as a pictures, video, sound, music, scent, texture, and narratives. A movie can also have one or more of these facets to cover a group of episodes. This relationship can be captured by a multi-root tree structure with facets as the leaf nodes, movies as the root nodes, and episodes in the middle layers. A more complex relation arises when part of a movie can be shared by another movie. One way to handle this situation is to partition the movie so that the shared parts are separated from the unshared parts. By creating a new root node for the entire movie and treating these parts as episodes, the multi-root tree structure can again be used to represent the relationship. In general, these representations can be called relation graphs.

For a quicker search, the relation graphs and the index can be linked. When a memory object is created from facets, text descriptions can be added as narratives. These texts may contain keywords that are not in the facets. Indexing them can help in searching for objects. For example, pointers to the facets that can be linked to a keyword or phrase can be stored in the entry of the index for the keyword or phrase. As another example, pointers to the memory objects that can be linked to a keyword or phrase can be stored in the entry of the index for the keyword or phrase.

In another embodiment of the present invention, a unique identification is obtained for a physical object that is the subject of the facet (e.g., a point of interest like the Eiffel tower captured in a photo, a consumer product with a bar code on it, etc.). This ID may either be obtained directly (via a bar code symbol, Quick Response (QR) symbol, or RFID tag on the object itself) or indirectly via detection software (e.g., image recognition software able to identify the Eiffel tower in a photo). The ID may then be attached to the facet and associated with the ultimate memory episode in which it is gathered. Sounds or smells may also be used to create unique signatures for the objects.

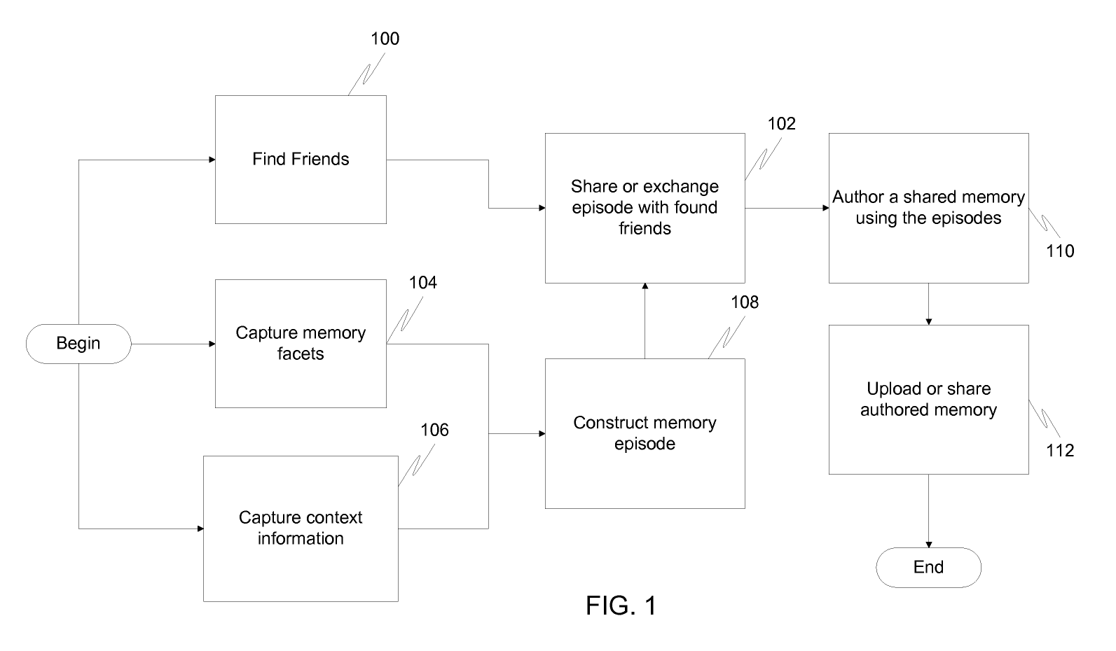

In another embodiment, capabilities that enable easy composition and editing of a shared memory among multiple users are provided. FIG. 1 is a flow diagram illustrating easy composition of a shared memory among multiple users in accordance with an embodiment of the present invention. A search engine or social networking services, such as FourSquare, may be provided to find friends who also visited England to watch the royal wedding, exchange photos/videos with them, and compose a shared story with them. At 100, friends may be found. At 102, an episode can be shared or exchanged with found friends. At 104, independently of the finding of friends, the facets of a memory can be captured. At 106, independently of the capturing of facets, context information related to the facet can be captured. At 108, a memory episode can be constructed from the facets and contexts, and this memory episode can be shared at 102. At 110, a shared memory can be authored using the episodes. At 112, the authored memory can be uploaded or shared. A memory story can be composed and/or edited individually one at a time. Alternatively, a shared memory story can be composed by a group of users by using a collaborative memory story composer.

A simple collaborative memory story composer can include a master editor and one or more client editors. The master editor maintains the consistency of a master copy of the object being composed. It can reside on a server or cloud, together with a master copy of the story. The client copy can be consistent with the last committed/saved master object. At any instant of time, only one of the client editors may have edit control (e.g., only one client editor can edit its copy of the object, while all other client editors can only view the object). Each edit can be reflected on all the client copies, but the master copy will have the edit only after the edit is successfully committed.

The collaborative editor can also provide video or audio communication channels so that the participants can communicate with each other while editing the memory object together. Once the team decides to commit/save and edit, the client editor with the editing control can then execute the commitment. If a client editor with no edit control exits (e.g., is closed), the master editor does not need to do anything except record the exit. If the client editor that has the edit control exists, then it can first pass the control to another client editor. However, if the control has not passed, the master editor can still take over the control and pass the control to one of the remaining client editors. If the edits have not been committed but have been reflected in the copy of the current client editor with the control, the current client can commit it. The master editor exists when all client editors have exited. More features can be included, including fault tolerance in the collaborative editor.

In another embodiment of the present invention, an interaction mood or activity cohesiveness of a group can be sensed and background suggestions of cues/topics that aid to facilitate group togetherness can be made, based on the mood and the degree of cohesiveness and based on the common interests and experiences of the group.

Examples of interaction mood include excited, happy, sad, and angry. Examples of activity cohesiveness include sharing a lot, having nothing to say, and busy doing separate things. The mood and cohesiveness of the group can be derived from sensor data. For example, the sound of conversation can be recorded and analyzed to identify how frequently group members talk to each other and how many people participate in the conversation. Emotional cues reflected in the sound can be derived to represent the mood. The system can also record the applications being used, the text entered (if any), and other activities of using the applications by each member. Speech recognition can also be used to identify keywords being spoken. The keywords and the text entered by each user can then be used to identify the topics of current conversation. From these data, the system can infer whether the members of the group are busy doing separate things or sharing the experience. For example, if a user has a lot of activities using applications that are different than the others, or communicating with people outside the group, he/she is most likely not participating in the group activities. The computation can be performed on a local server or in a cloud, however it can also be performed on a client device.

The system can also treat different factors differently, e.g., assigning more weight to more reliable or influential factors during the computation, so as to increase the accuracy of the assessment of the mood and cohesiveness.

The system can also derive common interests of the group. Typically, interests can include users' likes and dislikes. The interests of a user can be extracted by analyzing the profile of the user. A user profile can be set using demographic information, or specified by the user, or derived from the user's usage history, or any combination of these. A usage history is typically created by the system through recording users' usage/interactions with applications including creating, sharing, and viewing memory objects. Once the interests of individual users are obtained, common interests between individuals can be easily derived.

The system can also derive common experiences of the group. A simple way to implement this is to use memory object metadata, such as metadata identifying the people captured by the memory object, people who shared the object, people who liked the object, people who co-authored the object, etc. Another example would include using place locations from the metadata. Once again, speech to text conversion can be used to extract keywords and to identify possible topics in the conversation.

Based on the interaction mood and activity cohesiveness of the group, the system can decide to recommend memory objects that may facilitate better shared experiences. For example, if the system thinks the group is not in a good mood or group activities are highly incoherent, it may suggest memory objects that are of common interests and experiences. If the system finds that the group is already discussing a shared experience, it can retrieve a new related memory object that has not been discussed yet. The suggestions/recommendations may be performed in a non-intrusive way, such as by displaying the memory objects on a secondary screen (one that is not being primarily used by the group) with no sound.

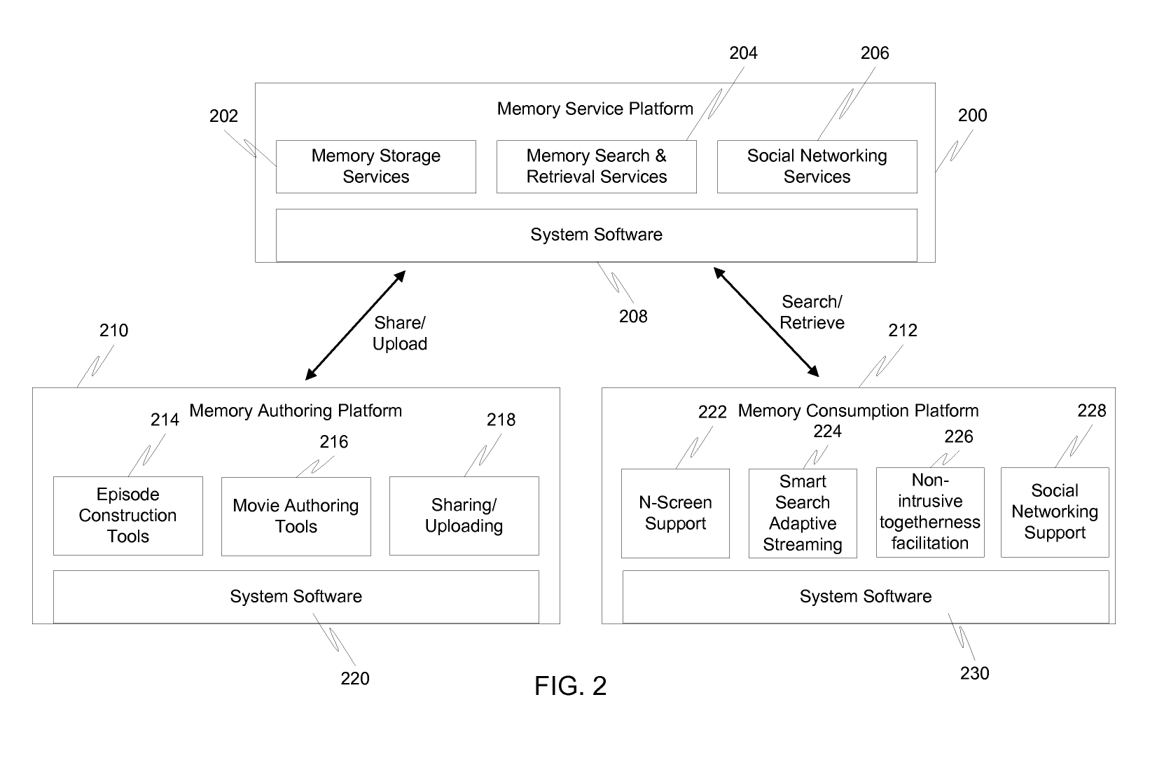

FIG. 2 is a block diagram illustrating a system in accordance with an embodiment of the present invention. A memory service platform 200 can be located in a cloud or at a home server, for example. The memory service platform can include memory storage services 202 memory search and retrieval services 204, and social networking services 206 as well as server/cloud system software 208 designed to interface with a memory authoring platform 210 and a memory consumption platform 212. A client device can host the memory authoring platform 210 and/or the memory consumption platform 212.

The memory authoring platform 210 can include episode construction tools 214, movie authoring tools 216, and an easy sharing and uploading module 218, as well as device system software 220 designed to store, share or upload memory objects and/or stories with the memory service platform 200. The user may utilize the memory authoring platform to capture facets, create and modify memory objects using the facets, construct episodes or movies from the facets, and share and upload all of the above to the memory service platform 200.

The memory consumption platform 212 can include n-screen support 222. N-screen support includes hardware and software for properly playing media content, such as images, drawings, photos, and videos, on devices with different form factors. Examiners of such devices include mobile phones, tablets, televisions, and PCs. The memory consumption platform 212 can also include smart search adaptive streaming 224, which allows a user to quickly locate matching memory objects and stories and stream those objects and stories to a display. A non-intrusive togetherness facilitation module 226 can also be provided to monitor group mood and cohesiveness and suggest memory objects or stories that will promote group togetherness. A social networking support module 228 can also be provided for finding friends, e.g., at a same place or same venue, or finding people with similar interests.

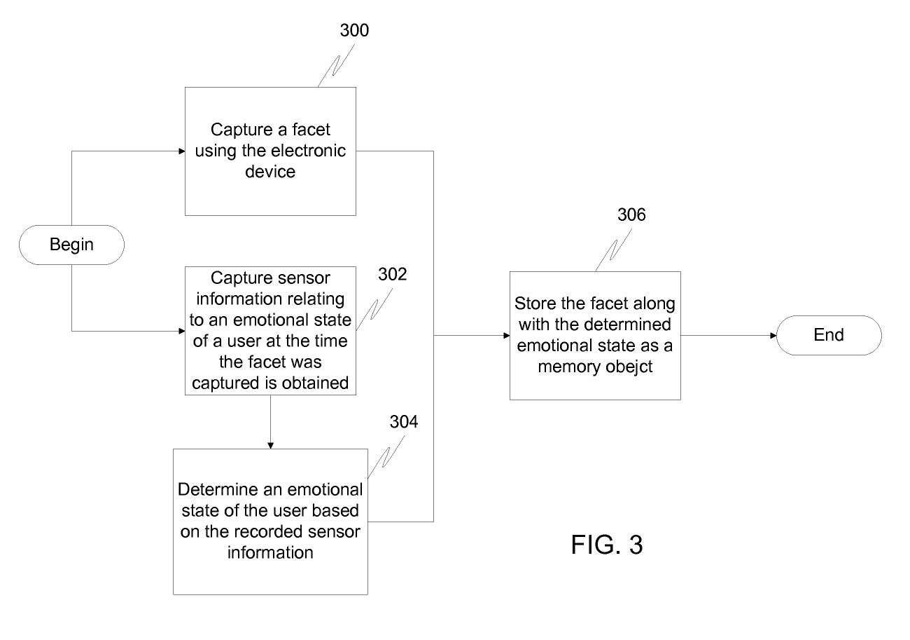

FIG. 3 is a flow diagram illustrating a method for creating a memory object on an electronic device in accordance with an embodiment of the present invention. At 300, a facet is captured using the electronic device. The facet may be, for example, a still picture, video, text message, etc. At 302, sensor information relating to an emotional state of a user of the electronic device at the time the facet was captured is obtained. As can be seen, steps 300 and 302 can be performed in any order. At 304, an emotional state of the user is determined based on the recorded sensor information. At 306, the facet is stored along with the determined emotional state as a memory object. The determined emotional state may be stored as metadata in the memory object.

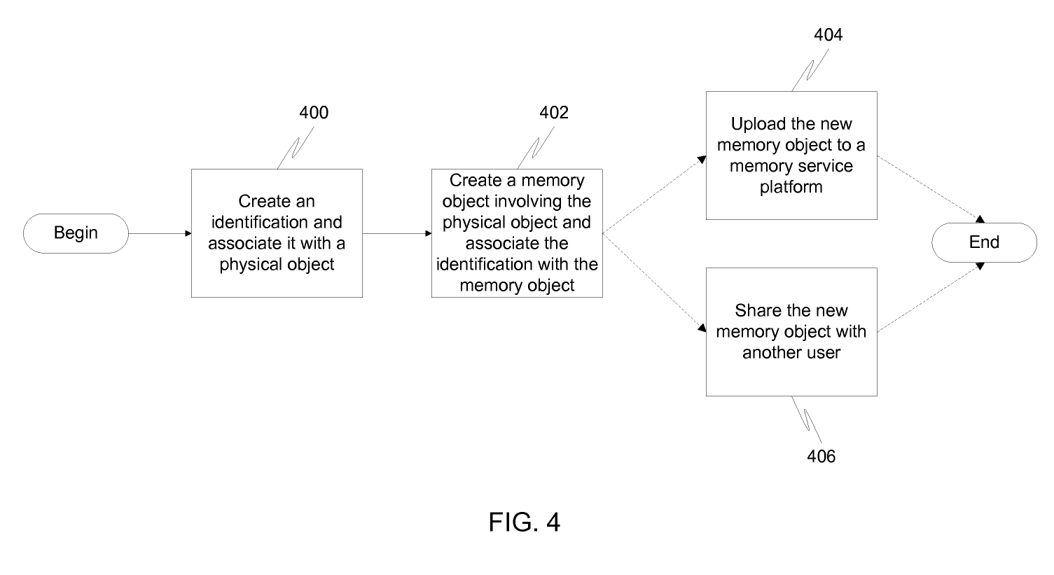

FIG. 4 is a flow diagram illustrating a method for associating a memory object with a physical object in accordance with one embodiment of the present invention. At 400, an identification may be created and associated with a physical object. This step may be performed by a product manufacturer or distributor, such as in the case where the ID is an RFID or bar code symbol. Alternatively, this step may be performed by a client device using some sort of detection software, such as image recognition software which identifies an object from a photograph. At 402, a memory object involving the physical object (e.g., a photograph of the object) is created and the identification previously created is associated with the memory object. At 404, the new memory object is uploaded to a memory service platform. Alternatively, at 406, the new memory object is shared with another user.

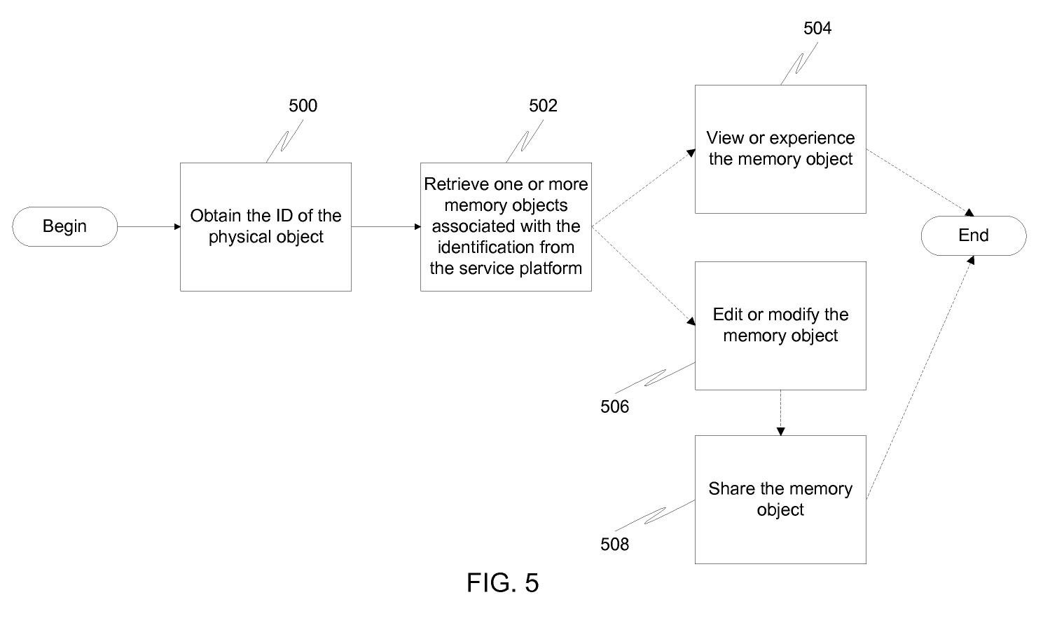

FIG. 5 is a flow diagram illustrating a method for using a memory object associated with a physical object in accordance with an embodiment of the present invention. At 500, the identification of the physical object is obtained. This may be performed, for example, through reading the RFID or barcode of the physical object. At 502, one or more memory objects associated with the identification are retrieved from the service platform. This may be performed, for example, through a search using the obtained identifications, or available metadata such as location, time, emotion, people, etc. At that point, at 504, the memory object may be viewed or experienced. Alternatively, the memory object can be edited or modified at 506 and uploaded or shared at 508.

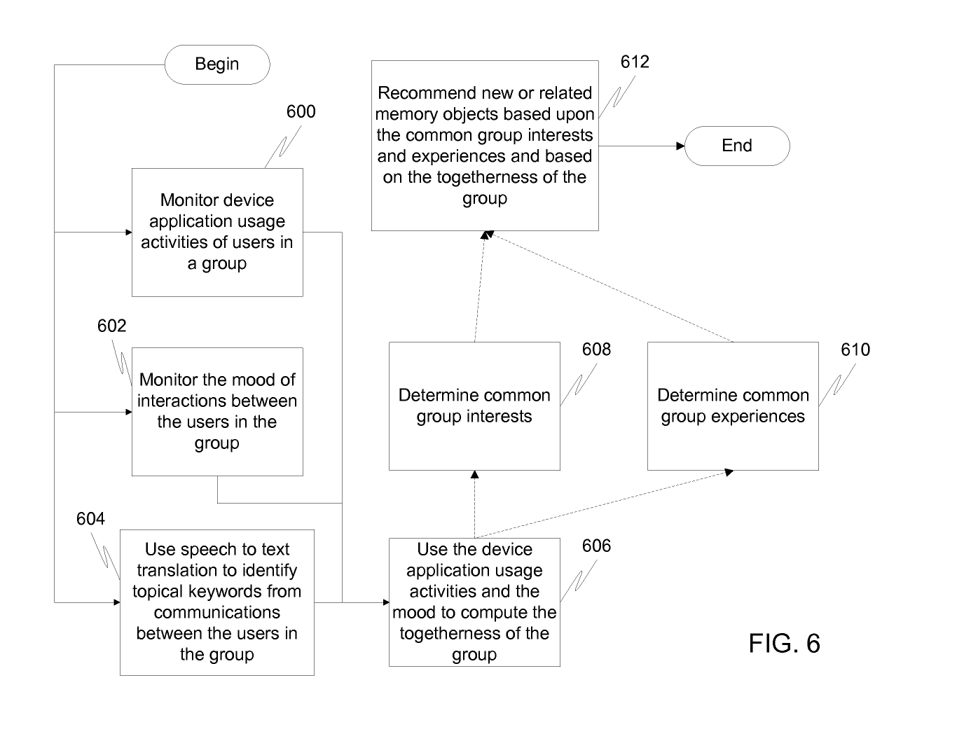

FIG. 6 is a flow diagram illustrating a method for facilitating group togetherness in accordance with an embodiment of the present invention. At 600, device application usage activities of users in a group are monitored. At 602, the mood of interactions between the users in the group is monitored. At 604, speech to text translation is used to identify topical keywords from communications between the users in the group. Note that, as can be seen, steps 600, 602, and 604 can be performed in any order.

At 606, the device application usage activities and the mood are used to compute the “togetherness” of the group. At 608, common group interests are determined. For example, the common interests can be obtained by computing the similarity between the interest profiles of the participants. Alternatively, at 610 common group experiences are determined. For example, the common experiences can be obtained y computing the similarity between the metadata of the memory objects of the participants. These may utilize the topical keywords identified in 604. Finally, at 612, new or related memory objects can be recommended based upon the common group interests and experiences and based on the togetherness of the group.

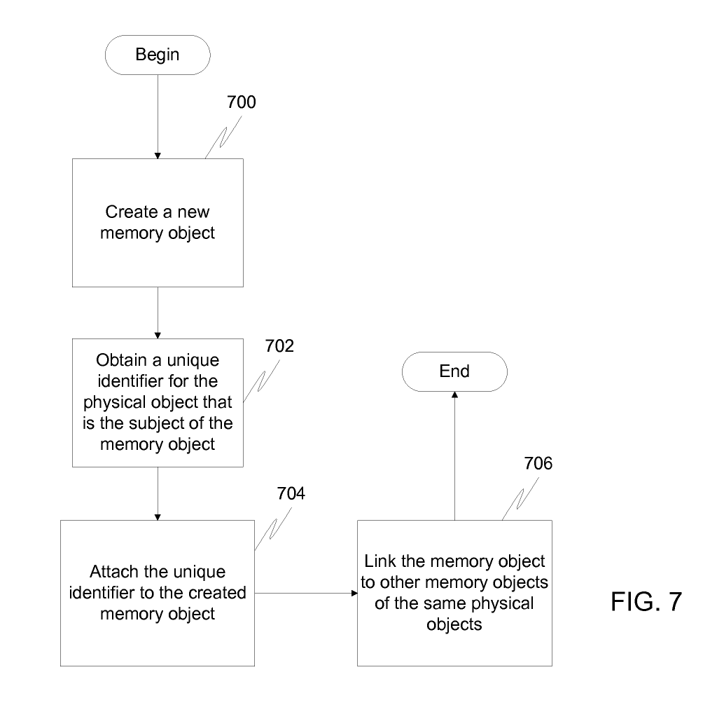

FIG. 7 is a flow diagram illustrating a method for adding a new memory object to existing memory objects of a physical object and the other memory objects of the physical object in accordance with an embodiment of the present invention. This method may be viewed as an add-on to the method of FIG. 4, although in some embodiments the method of FIG. 7 may be performed independently of some or all of the steps of FIG. 4. At 700, a new memory object is created. At 702, a unique identifier is obtained for the physical object that is the subject of the memory object. The unique identifier may be obtained, for example, by reading the RDID or barcode of the physical object, or may be a unique identification assigned to the physical object by image recognition software. At 704, the unique identifier is attached to the created memory object. At 706, the memory object is linked to other memory objects of the same physical objects.

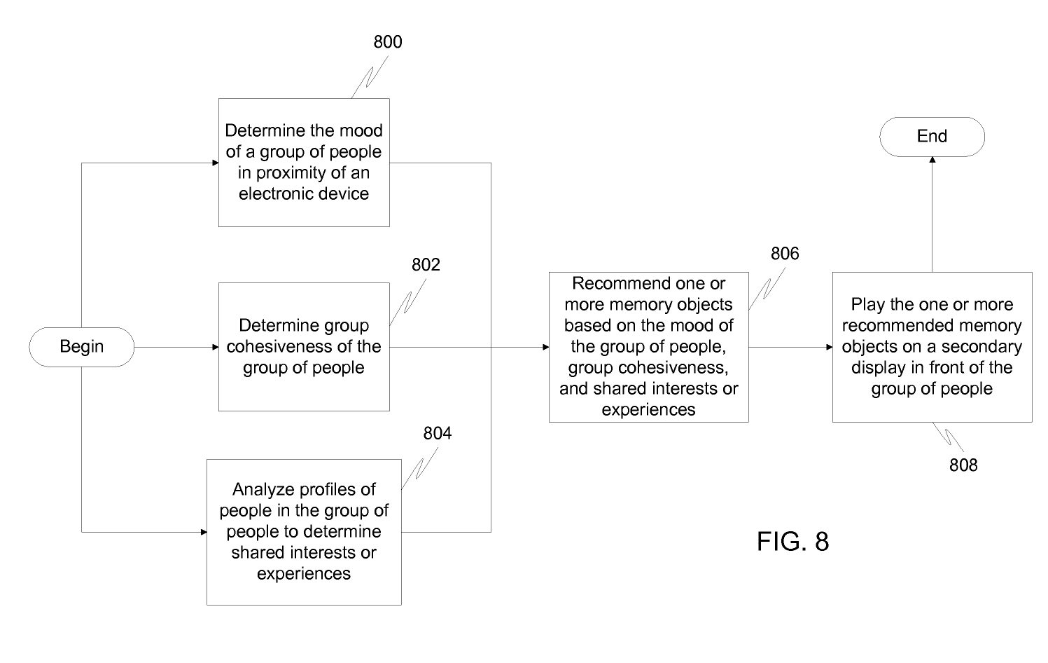

FIG. 8 is a flow diagram illustrating a method for recommending memory objects in accordance with an embodiment of the present invention. This may be viewed as an add-on to the method of FIG. 6 although in some embodiments the method of FIG. 8 may be performed independently of some or all of the steps of FIG. 6. At 800, the mood of a group of people in proximity of an electronic device may be determined. At 802, group cohesiveness of the group of people is determined. At 804, profiles of people in the group of people are analyzed to determine shared interests or experiences. Note that, as can be seen, steps 800, 802, and 804 can be performed in any order. At 806, one or more memory objects are recommended based on the mood of the group of people, group cohesiveness, and shared interests or experiences. At 808, the one or more recommended memory objects may be played on a secondary display in front of the group of people.

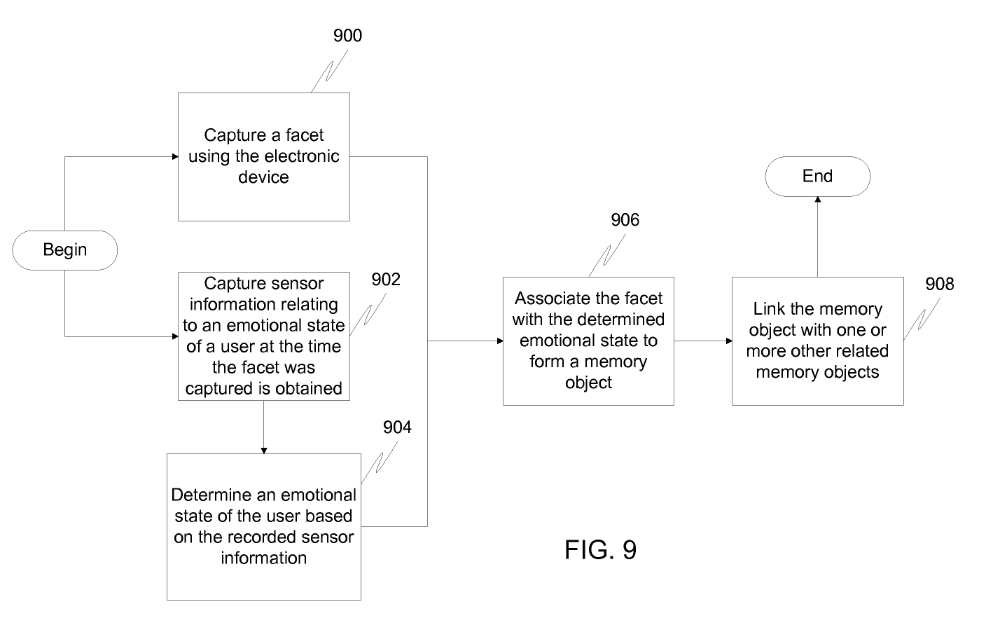

FIG. 9 is a flow diagram illustrating a method for creating a memory object on an electronic device in accordance with another embodiment of the present invention. At 900, a facet is captured using the electronic device. The facet may be, for example, a still picture, video, text message, etc. At 902, sensor information relating to an emotional state of a user of the electronic device at the time the facet was captured is obtained. As can be seen, steps 900 and 902 can be performed in any order. At 904, an emotional state of the user is determined based on the recorded sensor information. At 906, the facet is associated with the determined emotional state to form a memory object. At 908, the memory object is linked with one or more other related memory objects.

As will be appreciated to one of ordinary skill in the art, the aforementioned example architectures can be implemented in many ways, such as program instructions for execution by a processor, as software modules, microcode, as computer program product on computer readable media, as logic circuits, as application specific integrated circuits, as firmware, as consumer electronic device, etc. and may utilize wireless devices, wireless transmitters/receivers, and other portions of wireless networks. Furthermore, embodiment of the disclosed method and system for displaying multimedia content on multiple electronic display screens can take the form of an entirely hardware embodiment, an entirely software embodiment, or an embodiment containing both software and hardware elements.

The term “computer readable medium” is used generally to refer to media such as main memory, secondary memory, removable storage, hard disks, flash memory, disk drive memory, CD-ROM and other forms of persistent memory. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

Although only a few embodiments of the invention have been described in detail, it should be appreciated that the invention may be implemented in many other forms without departing from the spirit or scope of the invention. Therefore, the present embodiments should be considered illustrative and not restrictive and the invention is not to be limited to the details given herein, but may be modified within the scope and equivalents of the appended claims.

What is claimed is:

1. A method for creating a memory object on an electronic device, comprising:
capturing a facet using the electronic device;
recording sensor information relating to an emotional state of a user of the electronic device at the time the facet was captured;
determining an emotional state of the user based on the recorded sensor information; and
storing the facet along with the determined emotional state as a memory object.

2. The method of claim 1, further comprising linking the created memory object to other memory objects.

3. The method of claim 1, wherein the facet is a still picture.

4. The method of claim 1, wherein the facet is a video.

5. The method of claim 1, wherein the facet is a text message.

6. The method of claim 1, wherein the determined emotional state is stored as metadata in the memory object.

7. The method of claim 1, further comprising:
obtaining a unique identifier for a physical object that is the subject of the facet;
attaching the unique identifier to the memory object; and
linking the memory object to other memory objects having similar attached unique identifiers.

8. The method of claim 7, wherein the unique identifier is a radio frequency identification (RFID) and the obtaining involves using an RFID scanner to detect the unique identifier from an RFID tag on or affixed to the physical object.

9. The method of claim 7, wherein the unique identifier is a barcode and the obtaining involves using a barcode scanner to detect the unique identifier from a barcode on or affixed to the physical object.

10. The method of claim 7, wherein the unique identifier is obtained by using image recognition software to identify a predetermined object in the facet.

11. The method of claim 1, further comprising:
providing a master editing tool and one or more client editors, wherein the client editors allow individual users to modify copies of memory objects while the master editing tool maintains a master copy of each memory object and updates the master copy with changes from the one or more client editors

12. The method of claim 1, further comprising:
determining a mood of a group of people in proximity of the electronic device;
determining group cohesiveness of the group of people;
analyzing profiles of people in the group of people to determine shared interests or experiences; and
recommending one or more memory objects based on the mood of the group of people, group cohesiveness, and shared interests or experiences.

13. The method of claim 12, further comprising playing the one or more recommended memory objects on a secondary display in front of the group of people.

14. A device comprising:
a processor;
a memory;
one or more sensors designed to record sensor information relating to an emotional state of a user;
a facet capture device, wherein the facet capture device is designed to capture a facet;
wherein the processor is configured to determine an emotional state of the user based on the recorded sensor information, and store the facet along with the determined emotional state as a memory object in the memory.

15. The device of claim 14, wherein the facet capture device is a camera.

16. The device of claim 14, wherein the one or more sensors is a camera configured to work with facial recognition software.

17. The device of claim 14, wherein the one or more sensors include a heart rate monitor.

18. The device of claim 14, wherein the one or more sensors include a microphone configured to work with voice recognition software.

19. An electronic device comprising:
means for capturing a facet using the electronic device;
means for recording sensor information relating to an emotional state of a user of the electronic device at the time the facet was captured;
means for determining an emotional state of the user based on the recorded sensor information;
means for storing the facet along with the determined emotional state as a memory object; and
means for obtaining a unique identifier for a physical object that is the subject of the facet;
means for attaching the unique identifier to the memory object; and
means for linking the memory object to other memory objects having similar attached unique identifiers.

20. The electronic device of claim 19, wherein the means for obtaining a unique identifier for a physical object is a barcode scanner.

21. The electronic device of claim 19, wherein the means for obtaining a unique identifier for a physical object is a radio frequency identification (RFID) scanner.

22. A non-transitory program storage device readable by a machine tangibly embodying a program of instructions executable by the machine to perform a method for creating a memory object on an electronic device, comprising:
capturing a facet using the electronic device;
recording sensor information relating to an emotional state of a user of the electronic device at the time the facet was captured;
determining an emotional state of the user based on the recorded sensor information;
storing the facet along with the determined emotional state as a memory object; and
linking the memory object to other memory objects having similar stored emotional states.
